(19) United States
(12) Patent Application Publication
(10) Pub. No.: US 2009/0015527 A1
(43) Pub. Date: Jan. 15, 2009

(54) Liquid crystal display panel, adjusting method thereof and liquid crystal display

(75) Inventors: Te-Chen Chung, Kun Shan City (CN); Tean-Sen Jen, Kun Shan City (CN); Wenjun Dai, Kun Shan City (CN)

Correspondence Address: MORRISS OBRYANT COMPAGNI, P.C., 734 EAST 200 SOUTH, SALT LAKE CITY, UT, 84102, US

(73) Assignee: InfoVision Optoelectronics (Kunshan) Co., Ltd.

(21) Appl. No.: 12/156,312

(22) Filed: May 30, 2008

(30) Foreign Application Priority Data
Jul. 12, 2007 (CN) 200710128448.1

(51) Int. Cl. G09G 3/36

(52) U.S. Cl. 345/87

(57) ABSTRACT

The present invention relates to a liquid crystal display panel having an adjusting device and an adjusting method thereof. The adjusting device is configured to transmit a recovery voltage signal having a recovery voltage to a common electrode line corresponding to a scan line when a low-voltage scan signal is transmitted to the scan line, and form an adjusted voltage lower than the recovery voltage on the common electrode line when a high-voltage scan signal is transmitted to the scan line. The invention can reduce effectively flicker of a liquid crystal display panel and improve comfortableness of a user when viewing.

### FIELD OF THE INVENTION

The present invention relates to a field of liquid crystal display, and in particular to a liquid crystal display panel and an adjusting method thereof.

### BACKGROUND OF THE INVENTION

As compared with a traditional Cathode Ray Tube (CRT) display, a liquid crystal display (LCD) has a lot of advantages, such as space saving, power saving and so on. The liquid crystal display with large size and high definition has already been widely used in replacement of the traditional cathode ray tube display. However, the larger the size of the LCD is, the more serious flicker phenomenon of the LCD will be.

An approach to drive the liquid crystal display is Alternate Current (AC) driving, and a data signal is alternately varied between a positive region and a negative region. FIG. 11 is a partial structure diagram of a conventional liquid crystal display panel. The liquid crystal display panel includes scan lines 21 and data lines 22 which intersect with the scan lines 21, and each data line 22 and each scan line 21 are used to control a display unit 13. The display unit 13 includes a thin film transistor (TFT) 20, a liquid crystal capacitor 24 and a storage capacitor 25. The TFT 20 has a gate electrode connected with the scan line 21, a source electrode connected with the data line 22, and a drain electrode connected with a common terminal of the liquid crystal capacitor 24 and the storage capacitor 25. The other terminal of the storage capacitor 25 is connected with a common electrode line 23.

On or off state of the transistor 20 is controlled by a scan signal over the scan line 21. When the transistor 20 is turned on, a data signal over the data line 22 is transmitted to the liquid crystal capacitor 24 and the storage capacitor 25. Because each scan line 21 has a certain impedance, a plurality of liquid crystal capacitors 24, storage capacitors 25 and parasitic capacitances generated by a plurality of transistors 20, transmission of the scan signal over the scan line 21 will be influenced. A waveform of the scan signal may be distorted due to impedance effect and capacitance effect, thus variations of pixel voltages stored in the liquid crystal capacitors 24 of pixels on the same scan line may differ.

The larger the size of the liquid crystal display panel is, the longer the scan line 21 is, and correspondingly impedance of the scan line is also increased. The higher the definition of the liquid crystal display panel is, the more cross points between the scan lines 21 and the data lines 22 are, the more parasitic capacitances on the scan lines 21 are, and correspondingly parasitic capacitance of each scan line 21 is also increased. So during transmission of the scan signal over the scan line 21, the scan signal is affected greatly due to impedance effect and capacitance effect, the difference in variations of pixel voltages is exacerbated, and feedthrough voltages of pixel voltages may have different variation amounts at different pixels on the same scan line 21.

FIG. 12 is a schematic diagram illustrating transmission of the scan signal and a pixel voltage from a start terminal of the scan line to an end terminal thereof in the liquid crystal display panel, in which the real line represents a schematic diagram illustrating transmission of the pixel voltage, and the broken line represents a schematic diagram illustrating transmission of the scan signal. The scan signal comes in a square wave form at the start terminal of the scan line 21, while square wave signal is distorted at the end terminal of the scan line due to impedance effect and capacitance effect, so that variations of feedthrough voltages ΔVp, ΔVpd, at different pixels are different. FIG. 13 is a diagram illustrating variations of the feedthrough voltage of the pixel voltage from the start terminal of the scan line to the end terminal thereof, where A, B and C represent different locations between the start terminal and the end terminal of the same scan line 21 in the liquid crystal display panel, respectively. As can be seen from FIG. 3, ΔVpd, a variation of the feedthrough voltage ΔVp between the two points A and C on the same scan line 21, is relatively large, as a result, flicker of the liquid crystal display panel may be serious, which will directly influence comfortableness of a user when viewing.

### SUMMARY OF THE INVENTION

The invention is to provide a liquid crystal display panel, an adjusting method thereof and a liquid crystal display, which can reduce effectively flicker of the liquid crystal display panel and improve comfortableness of a user when viewing.

The invention relates to a liquid crystal display panel comprising scan lines and data lines arranged in a matrix, display units disposed at which the scan lines cross with the data lines, a data driver coupled with the data lines, a scan driver coupled with the scan lines, and an adjusting device. The adjusting device is configured to transmit a recovery voltage signal having a recovery voltage to a common electrode line corresponding to a scan line when a low-voltage scan signal is transmitted to the scan line, and form an adjusted voltage lower than the recovery voltage on the common electrode line when a high-voltage scan signal is transmitted to the scan line.

The invention also relates to an adjusting method of a liquid crystal display panel comprising steps of: transmitting a scan signal in sequence to each scan line; forming an adjusted voltage signal on a corresponding common electrode line when a high-voltage scan signal is transmitted to the scan line; transmitting to the common electrode line, a recovery voltage signal having a recovery voltage higher than a voltage of the adjusted voltage signal when a low-voltage scan signal is transmitted to a scan line; and compensating positively for a feedthrough voltage by a coupled voltage resulting from a voltage of the common electrode line and a pixel electrode on the scan line.

The invention still relates to a liquid crystal display comprising scan lines and data lines arranged in a matrix, a plurality of common electrode lines, a data driver coupled with the data lines, a scan driver coupled with the scan lines, and an adjusting device. The adjusting device is configured to transmit a recovery voltage signal having a recovery voltage to a corresponding common electrode line when a low-voltage scan signal is transmitted to a scan line, and form an adjusted voltage lower than the recovery voltage on the common electrode line when a high-voltage scan signal is transmitted to the scan line.

During transmission over the scan line, the voltage on the common electrode line is also subject to impedance effect and capacitance effect in a similar way to the scan signal, a coupled voltage resulting from the voltage on the common electrode line and a pixel electrode may just compensate for ΔVpd, a variation of a feedthrough voltage ΔVp, so that the variations of the feedthrough voltages ΔVp, ΔVpd, at different locations of the same scan line may be reduced, thereby reducing flicker of the liquid crystal display panel and improving comfortableness of a user when viewing.

### BRIEF DESCRIPTION OF THE DRAWINGS

FIG. 1 is a partial schematic diagram of a liquid crystal display panel having an adjusting device according to an embodiment of the invention;

FIG. 2 is a schematic diagram of the adjusting device of FIG. 1;

FIG. 3 is a schematic diagram of a liquid crystal display having the liquid crystal display panel of FIG. 1;

FIG. 4 is a partial schematic diagram of a liquid crystal display panel having a pair of adjusting devices according to another embodiment of the invention;

FIG. 5 is a schematic diagram of another liquid crystal display having the liquid crystal display panel of FIG. 4;

FIG. 6 is a circuit configuration diagram of the adjusting device of FIG. 5;

FIG. 7 is a variation waveform illustrating a common voltage on the common electrode line and a scan signal from a start terminal of a scan line to an end terminal thereof;

FIG. 8 is a simulation diagram of variation waveforms of a pixel voltage, the common voltage and the scan signal;

FIG. 9 is a partial enlarged diagram of FIG. 8;

FIG. 10 is a flow chart of an adjusting method for a liquid crystal display panel according to the invention;

FIG. 11 is a partial equivalent circuit diagram of a conventional liquid crystal display panel;

FIG. 12 is a waveform illustrating transmission of a scan signal and a pixel voltage from a start terminal of a scan line to an end terminal thereof in the liquid crystal display panel of FIG. 11; and

FIG. 13 is a diagram illustrating variation of a feedthrough voltage of the pixel voltage of FIG. 12.

### DETAILED DESCRIPTION OF THE EMBODIMENTS

The invention will be described in details hereinafter with reference to the accompanying drawings and preferred embodiments to make the above objects, features and advantages of the invention more apparent.

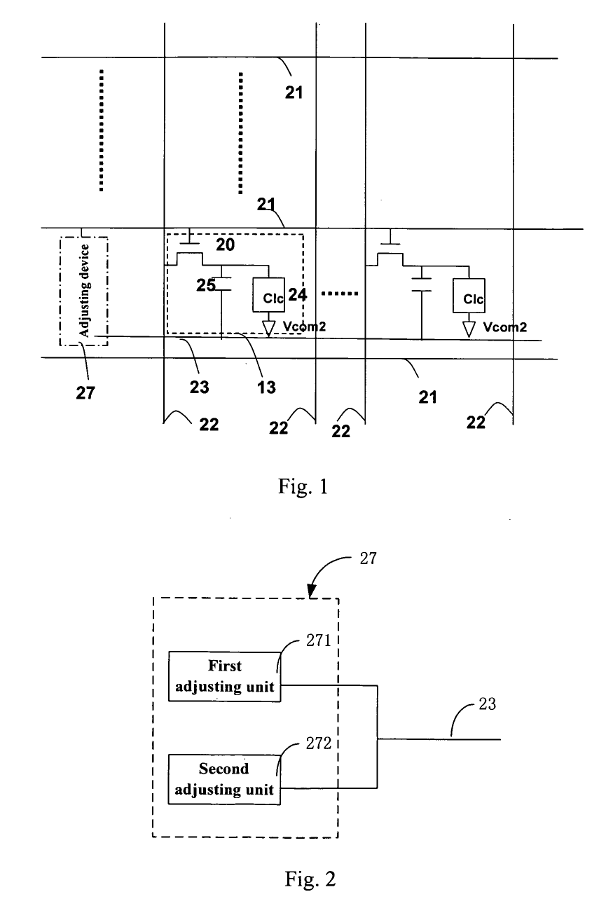

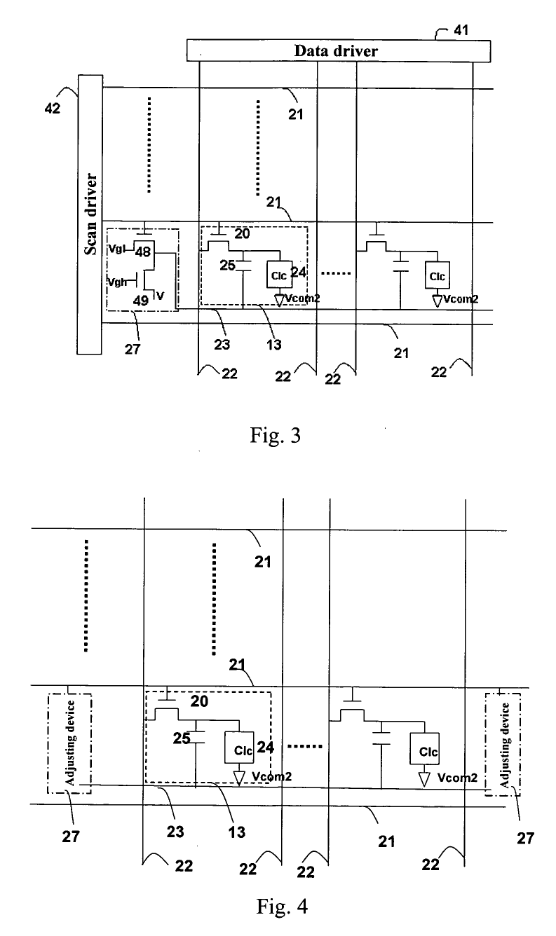

Referring to FIGS. 1-3, a liquid crystal display comprises a liquid crystal display panel, a data driver 41 and a scan driver 42. The liquid crystal display panel comprises a plurality of scan lines 21, a plurality of data lines 22, display units 13 and common electrode lines 23. The scan lines 21 and the data lines 22 are arranged in a matrix. The display units 13 are disposed at which the scan lines 21 cross with the data lines 22, each of which comprises a thin film transistor (TFT) 20, a liquid crystal capacitor 24 and a storage capacitor 25. The data driver 41 is coupled with the plurality of data lines 22 and is adapted to transmit image data signals to the display units 13 through the data lines 22. The scan driver 42 is coupled with the plurality of scan lines 21 and is adapted to transmit scan signals to the corresponding scan lines 21. The scan signal may be a high-voltage scan signal having a high scan voltage which causes the TFT to attain an ON state or a low-voltage scan signal having a low scan voltage which causes the TFT to attain an OFF state.

The liquid crystal display panel in accordance with an embodiment of the present invention further comprises an adjusting device 27 (as shown is FIG. 1) which may be disposed between start terminals of a scan line 21 and its corresponding common electrode line 23, and is connected with the start terminals of the scan line 21 and the common electrode line 23. The start terminal of the scan line 21 is an input terminal of a scan signal and an end terminal of the scan line 21 is a terminal far from the start terminal thereof. The start terminal of the common electrode line 23 is located at the same side as that of the scan line 21. The end terminal of the common electrode line 23 is located at the same side as that of the scan line 21.

The adjusting device is configured to transmit a recovery voltage signal having a recovery voltage to a common electrode line corresponding to a scan line when a low-voltage scan signal is transmitted to the scan line, and form an adjusted voltage lower than the recovery voltage on the common electrode line when a high-voltage scan signal is transmitted to the scan line. The adjusting device 27 includes a first adjusting unit 271 and a second adjusting unit 272. Output terminals of the first adjusting unit 271 and the second adjusting unit 272 of the adjusting device 27 are both connected with the start terminal of the common electrode line. The first adjusting unit 271 is in operation to transmit a low voltage signal to a common electrode line 23 corresponding to a certain scan line from the start terminal of the common electrode line 23 when a high-voltage scan signal is transmitted to the scan line 21. The second adjusting unit 272 is configured to transmit a recovery voltage signal to the common electrode line 23 when either a high-voltage scan signal or a low-voltage scan is transmitted to the scan line, that is, the second adjusting unit 272 is always in operation. So the adjusted voltage is formed on the common electrode line by the first and the second adjusting units 271, 272 when a high-voltage scan signal is transmitted to the scan line 21.

The common electrode line 23 has different voltages when a high-voltage scan signal is transmitted to the scan line and when a low-voltage scan signal is transmitted to the scan line, so the common electrode line 23 has a voltage variation ΔVcom when a scan signal transmitted to the scan line ranges from a high-voltage scan signal to a low-voltage scan signal. Because the voltage on the common electrode line is also subject to impedance effect and capacitance effect during transmission of the recovery voltage signal and the low voltage signal over the scan line in a similar way to the scan signal, a coupled voltage resulting from the voltage on the common electrode line and a pixel electrode may just compensate for a variation of a feedthrough voltage ΔVp, ΔVpd, so that variations of the feedthrough voltages ΔVp, ΔVpd, at different locations of the same scan line may be reduced, thereby reducing flicker of the liquid crystal display panel and improving comfortableness of a user when viewing.

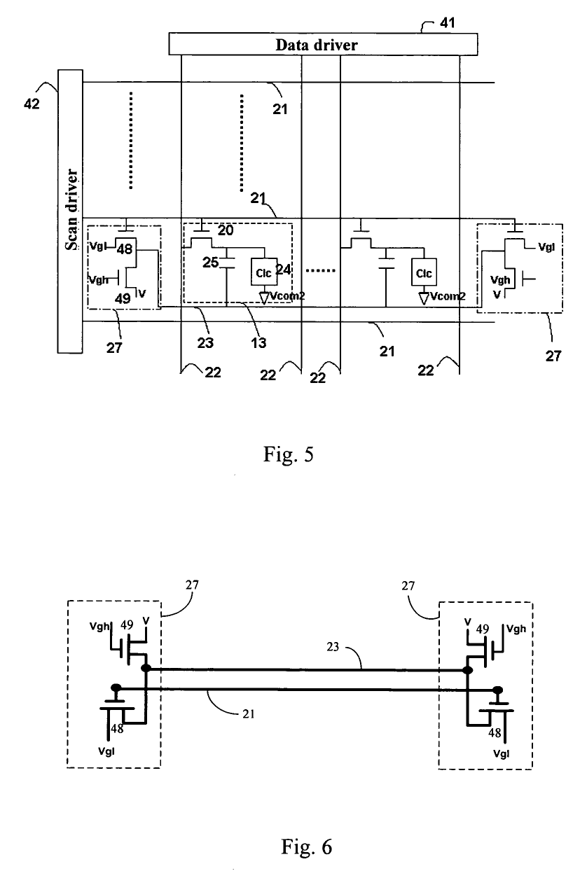

FIG. 4 shows a liquid crystal display panel in accordance with another embodiment of the present invention. FIG. 5 shows a liquid crystal display having the liquid crystal display panel of FIG. 4. The difference from the above embodiment is in that the liquid crystal display panel comprises a pair of adjusting devices 27. One of the adjusting devices 27 is disposed between start terminals of a scan line 21 and a common electrode line 23, and the other adjusting device 27 is disposed between end terminals of the scan line 21 and the common electrode line 23. The adjusting devices are configured to transmit recovery voltage signals having a recovery voltage to the start terminal and the end terminal of a corresponding common electrode line, respectively, when a low-voltage scan signal is transmitted to a scan line, and form an adjusted voltage lower than the recovery voltage at the start terminal and the end terminal of the common electrode line, respectively, when a high-voltage scan signal is transmitted to the scan line. Each of the adjusting devices 27 comprises a first adjusting unit 271 and a second adjusting unit 272. Output terminals of the first adjusting unit 271 and the second adjusting unit 272 of one of the adjusting device 27 are both connected with the start terminal of the common electrode line 23. Output terminals of the first adjusting unit 271 and the second adjusting unit 272 of the other adjusting device 27 are both connected with the end terminal of the common electrode line 23.

The first adjusting units 271 are configured to transmit low voltage signals to a common electrode line 23 from the start terminal and the end terminal of the common electrode line 23, respectively, when a high-voltage scan signal is transmitted to a scan line 21. The second adjusting units 272 are configured to transmit recovery voltage signals to the common electrode line 23 from the start terminal and the end terminal of the common electrode line 23, respectively, when either a high-voltage scan signal or a low-voltage scan is transmitted to the scan line. So the adjusted voltage is formed on the common electrode line by the first and the second adjusting units 271, 272 when a high-voltage scan signal is transmitted to the scan line 21.

When the liquid crystal display panel is relatively large in size and correspondingly the scan line 21 is relatively long, the adjusting devices 27 may transmit the low voltage signals and the recovery voltage signals to the common electrode line 23 from both the start terminal and the end terminal of the common electrode line 23, thereby reducing a delay of signal transmission over the common electrode line 23 and further improving adjustment effect.

Referring to FIG. 6, the first adjusting unit 271 includes, for example, a first transistor 48, and the second adjusting unit 272 includes, for example, a second transistor 49. The first transistor 48 has a gate electrode connected with the scan line 21, a source electrode connected with a low scan voltage source Vg1, and a drain electrode connected with the common electrode line 23. The second transistor 49 has a gate electrode connected with a high scan voltage source Vgh, a source electrode connected with a variable voltage source V, and a drain electrode connected with the common electrode line 23.

The first transistor 48 is adapted to transmit a low voltage signal to the common electrode line 23 corresponding to the scan line 21. When a high-voltage scan signal is transmitted to a certain scan line 21, the high-voltage scan signal is transmitted to the gate electrode of the first transistor 48 through the scan line 21. Because the high scan voltage is higher than a threshold voltage of the first transistor 48, the first transistor 48 is turned on. The first transistor 48 transmits the low voltage signal to the common electrode line 23. When the low-voltage scan signal is transmitted to the scan line 21, the low-voltage scan signal is transmitted to the gate electrode of the first transistor 48 through the scan line 21. Because the low scan voltage is lower than the threshold voltage of the first transistor 48, the first transistor 48 is turned off.

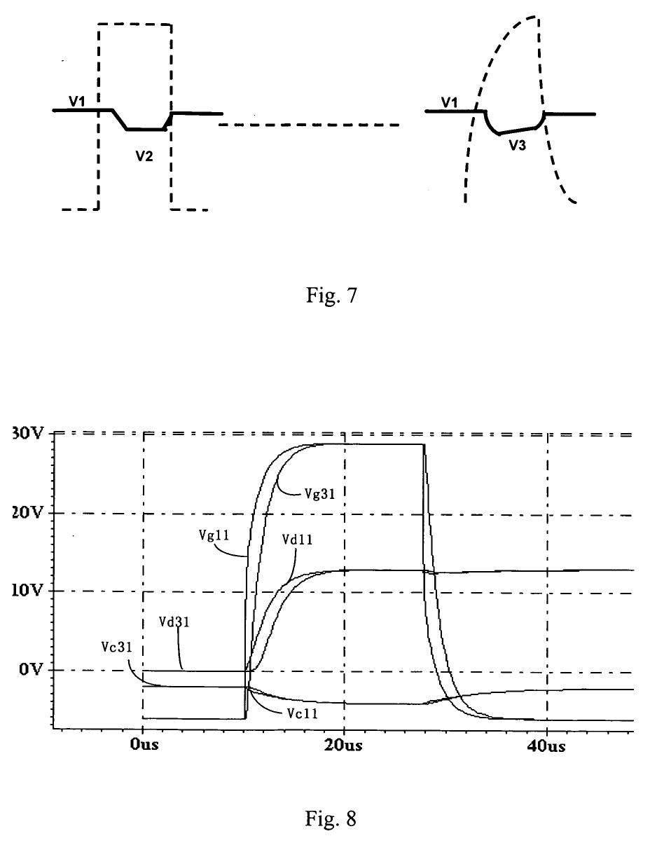

The second transistor 49 is adapted to transmit a recovery voltage signal V1 to the common electrode line 23 corresponding to the scan line 21. Because the high scan voltage source Vgh has a voltage higher than a threshold voltage of the second transistor 49, the second transistor 49 is in an ON state all the time. The second transistor 49 transmits the recovery voltage signal V1 to the common electrode line 23 all along. So when a high-voltage scan signal is transmitted to a scan line 21, the first transistor and the second transistor are both turned on and form an adjusted voltage V2 on a common electrode line 23 corresponding to the scan line 21 (as shown in FIG. 7). The low voltage signal Vd is above the low scan voltage Vg1 and below the recovery voltage V1.

The first transistor 48 and the second transistor 49 can also include a preset number of connected transistors. For instance, three transistors in an effective connection can function as a transistor, thus they are equivalent to a first transistor 48 or a second transistor 49.

FIG. 7 is a variation waveform illustrating a common voltage transmitted to the common electrode line and a scan signal from a start terminal of a scan line to an end terminal thereof, in which the real line represents a variation waveform of the common voltage, and the broken line represents a variation waveform of the scan signal. The common voltage on the common electrode line is coupled with a pixel electrode through the storage capacitor 25 of the display unit 13 in order to positively compensate for a pixel voltage. At the start terminal of the common electrode line 23, the common electrode line 23 whose voltage is varied from V2 to V1 has a relatively large variation, a feedthrough voltage ΔVp of the pixel electrode is also relatively large, so the relatively large variation of the voltage on the common electrode line 23 can just compensate positively for the relatively large feedthrough voltage ΔVp. A scan signal in a square wave form is distorted during transmission due to impedance effect and capacitance effect. At the end terminal of the common electrode line, the common electrode line 23 whose voltage is varied from V3 to V1 with little variation, the feedthrough voltage ΔVp of the pixel electrode is also relatively small, so the little variation of the voltage on the common electrode line 23 can just compensate positively for the relatively small feedthrough voltage ΔVp. The feedthrough voltage ΔVp of the pixel electrode can vary smoothly due to compensation of a coupled voltage resulting from the voltage on the common electrode line and the pixel electrode.

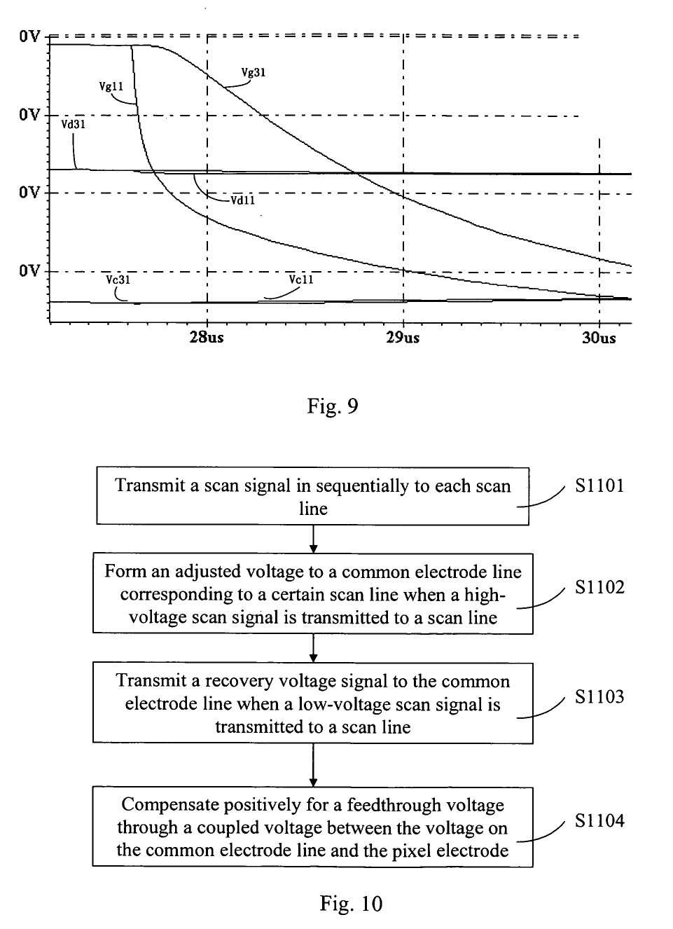

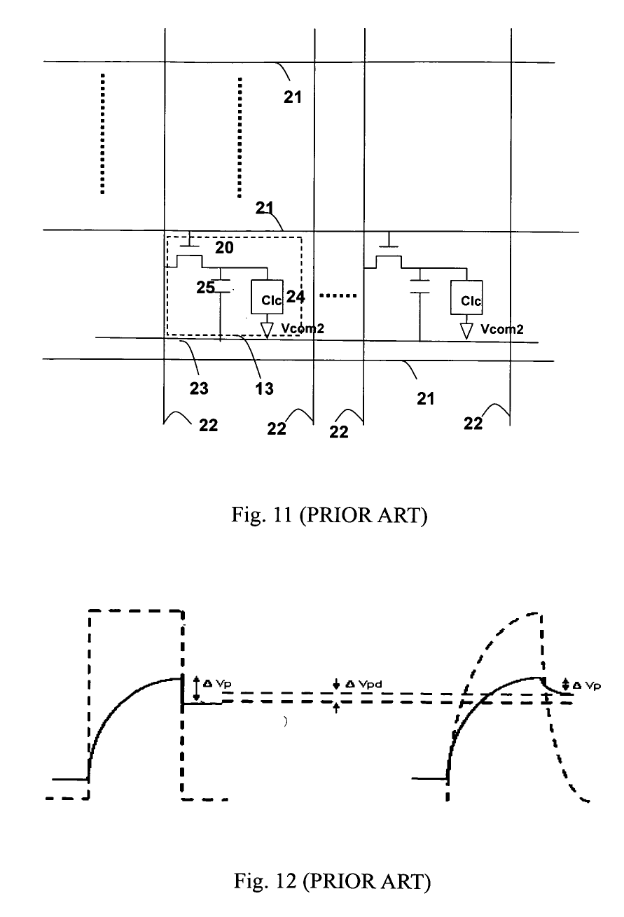

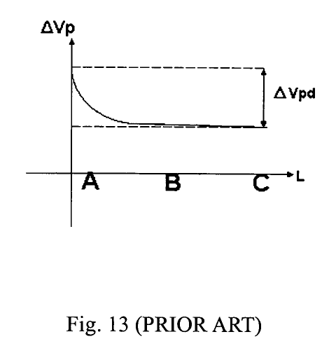

FIG. 8 is a simulation diagram of variation waveforms of a pixel voltage, a common voltage and a scan signal. FIG. 9 is a partial enlarged diagram of FIG. 8. As shown in FIG. 8 and FIG. 9, Vc11 indicates a variation curve of the common voltage of the first pixel unit on the scan line; Vc31 indicates a variation curve of the common voltage of the last pixel unit on the scan line; Vd11 indicates a variation curve of the pixel voltage of the first pixel unit on the scan line; Vd31 indicates a variation curve of the pixel voltage of the last pixel unit on the scan line; Vg11 indicates a variation curve of the scan signal at the first pixel unit on the scan line; and Vg31 indicates a variation curve of the scan signal at the last pixel unit on the scan line.

The pixel voltage varies smoothly due to compensation of the coupled voltage resulting from the voltage on the common electrode line and the pixel electrode. As can be seen from FIG. 9, Vd11, the variation curve of the pixel voltage of the first pixel unit on the scan line, almost overlaps with Vd31, the variation curve of the pixel voltage of the last pixel unit. ΔVpd, a variation of a feedthrough voltage between the pixels, is controlled to be blow 17 MV, while ΔVpd, a variation of a feedthrough voltage in a conventional liquid crystal display panel, is about 70 MV. Therefore, the embodiments of the invention can reduce significantly ΔVpd, the variation of the feedthrough voltage, so as to reduce effectively flicker of the liquid crystal display panel, compared with the conventional liquid crystal display panel.

Furthermore, the invention provides an adjusting method of the above liquid crystal display panel. Referring to FIG. 10, the adjusting method of the liquid crystal display panel in accordance with the present invention includes the following steps.

At step S1101, a scan signal is transmitted in sequence to each scan line 21.

Each scan line 21 of the liquid crystal display panel is coupled with the scan driver, and each data line 22 is coupled with the data driver. The scan driver transmits the scan signal in sequence to each scan line 21, and the TFTs of the display units 13 on only one of the scan lines 21 are turned on at a certain time.

At step S 1102, an adjusted voltage is formed on a common electrode line 23 corresponding to a certain scan line 21 when a high-voltage scan signal is transmitted to the scan line.

When a high-voltage scan signal is transmitted through a certain scan line 21, the TFTs of the display units 13 on the scan line are turned on. The data driver transmits an image data signal to a corresponding display unit 13 via a data line 22. Each scan line 21 corresponds to a common electrode line 23. When the scan signal is transmitted to a certain scan line 21, an adjusted voltage V2 is formed on a common electrode line 23 corresponding to the scan line 21, thereby pulling down the voltage of the common electrode line 23.

At step S1103, a recovery voltage signal V1 is transmitted to the common electrode line 23 when a low-voltage scan signal is transmitted to the scan line.

The adjusted voltage V2 is above the low scan voltage Vg1 and below the recovery voltage V1.

At step S1104, a coupled voltage resulting from the voltage on the common electrode line and the pixel electrode on the scan line 21 positively compensates for a feedthrough voltage.

The liquid crystal display panel and the adjusting method thereof according to the invention have been described in detail as above, and principles and embodiments of the invention have been set forth by way of specific examples. The above description of the embodiments is merely for the purpose of facilitating understanding of the inventive method and the essential idea thereof. Those skilled in the art can make modifications to the embodiments and their application in light of the inventive idea. In summary, the disclosure of the descriptions shall not be taken as limiting the scope of the invention.

What is claimed is:

1. A liquid crystal display panel, comprising:
a plurality of scan lines;
a plurality of data lines;
a plurality of common electrode lines; and
an adjusting device, wherein the adjusting device is configured to transmit a recovery voltage signal having a recovery voltage to a common electrode line corresponding to a scan line when a low-voltage scan signal is transmitted to the scan line, and form an adjusted voltage lower than the recovery voltage on the common electrode line when a high-voltage scan signal is transmitted to the scan line.

2. The liquid crystal display panel according to claim 1, wherein the adjusting device is connected with start terminals of the scan line and the common electrode line.

3. The liquid crystal display panel according to claim 2, wherein the adjusting device comprises a first adjusting unit and a second adjusting unit, and output terminals of the first adjusting unit and the second adjusting unit are connected with the start terminal of the common electrode line.

4. The liquid crystal display panel according to claim 3, wherein the second adjusting unit is configured to transmit the recovery voltage signal to the common electrode line when the scan signal is either the high-voltage scan signal or the low-voltage scan signal, wherein the first adjusting unit is configured to transmit a low voltage signal to the common electrode line when a high-voltage scan signal is transmitted to the scan line, and wherein the adjusted voltage on the common electrode line is formed by the first and the second adjusting units.

5. The liquid crystal display panel according to claim 4, wherein the first adjusting unit comprises a transistor, the transistor having a gate electrode connected with the scan line, a source electrode connected with a low scan voltage source, and a drain electrode connected with the common electrode line.

6. The liquid crystal display panel according to claim 5, wherein the adjusted voltage is above a voltage of the low-voltage scan signal and below the recovery voltage.

7. The liquid crystal display panel according to claim 4, wherein the second adjusting unit comprises a transistor, the transistor having a gate electrode connected with a high scan voltage source, a source electrode connected with a variable voltage source, and a drain electrode connected with the common electrode line.

8. The liquid crystal display panel according to claim 1, further comprising another adjusting device, and wherein the adjusting devices are connected with start terminals and ends terminals of the scan line and the common electrode line, respectively.

9. The liquid crystal display panel according to claim 8, wherein the adjusting devices are configured to transmit recovery voltage signals having a recovery voltage to the start terminal and the end terminal of a corresponding common electrode line, respectively, when a low-voltage scan signal is transmitted to a scan line, and form an adjusted voltage lower than the recovery voltage at the start terminal and the end terminal of the common electrode line, respectively, when a high-voltage scan signal is transmitted to the scan line.

10. The liquid crystal display panel according to claim 9, wherein each of the adjusting devices comprises a first adjusting unit and a second adjusting unit, and wherein output terminals of the first adjusting unit and the second adjusting unit of one adjusting device are connected with the start terminal of the common electrode line, and output terminals of the first adjusting unit and the second adjusting unit of the other adjusting device are connected with the end terminal of the common electrode line.

11. The liquid crystal display panel according to claim 10, wherein the second adjusting unit is configured to transmit the recovery voltage signal to the common electrode line when the scan signal is either the high-voltage scan signal or the low-voltage scan signal, wherein the first adjusting unit is configured to transmit a low voltage signal to the common electrode line when a high-voltage scan signal is transmitted to the scan line, and wherein the adjusted voltage on the common electrode line is formed by the first and the second adjusting units.

12. The liquid crystal display panel according to claim 11, wherein the first adjusting unit comprises a transistor, the transistor having a gate electrode connected with the scan line, a source electrode connected with a low scan voltage source, and a drain electrode connected with the common electrode line.

13. The liquid crystal display panel according to claim 12, wherein the adjusted voltage is above a voltage of the low-voltage scan signal and below the recovery voltage.

14. The liquid crystal display panel according to claim 11, wherein the second adjusting unit comprises a transistor, the transistor having a gate electrode connected with a high scan voltage source, a source electrode connected with a variable voltage source, and a drain electrode connected with the common electrode line.

15. An adjusting method of a liquid crystal display panel, comprising:
transmitting a scan signal in sequence to each scan line;
forming an adjusted voltage on a corresponding common electrode line when a high-voltage scan signal is transmitted to a scan line;
transmitting to the common electrode line, a recovery voltage signal having a recovery voltage higher than the adjusted voltage when a low-voltage scan signal is transmitted to the scan line; and
compensating positively for a feedthrough voltage by a coupled voltage resulting from a voltage of the common electrode line and a pixel electrode on the scan line.

16. The method according to claim 15, wherein the forming the adjusted voltage on the common electrode line when a high-voltage scan signal is transmitted to the scan line comprises:
transmitting, by a first adjusting unit of an adjusting device, a low voltage signal to the common electrode line, and
transmitting, by a second adjusting unit of an adjusting device, the recovery voltage signal to the common electrode line when a high-voltage scan signal is transmitted to the scan line.

17. The method according to claim 16, wherein the transmitting a recovery voltage signal to the common electrode line when a low-voltage scan signal is transmitted to a scan line comprising transmitting, by the second adjusting unit of the adjusting device, the recovery voltage signal to the common electrode line when a low-voltage scan signal is transmitted to the scan line.

18. The method according to claim 17, wherein the first adjusting unit comprises at least one transistor having a gate electrode connected with the scan line, a source electrode connected with a low scan voltage source, and a drain electrode connected with the common electrode line.

19. The method according to claim 18, wherein the adjusted voltage is above a voltage of the low-voltage scan signal and below the recovery voltage.

20. The method according to claim 17, wherein the second adjusting unit comprises at least one transistor having a gate electrode connected with a high scan voltage source, a source electrode connected with an adjustable voltage source, and a drain electrode connected with the common electrode line.

21. A liquid crystal display comprising:
scan lines and data lines arranged in a matrix,
a plurality of common electrode lines,
a data driver coupled with the data lines,
a scan driver coupled with the scan lines, and
an adjusting device, wherein the adjusting device is configured to transmit a recovery voltage signal having a recovery voltage to a corresponding common electrode line when a low-voltage scan signal is transmitted to a scan line, and form an adjusted voltage lower than the recovery voltage on the common electrode line when a high-voltage scan signal is transmitted to the scan line.

22. The liquid crystal display according to claim 21, wherein the adjusting device is connected with start terminals of the scan line and the common electrode line.

23. The liquid crystal display according to claim 22, wherein the adjusting device comprises a first adjusting unit and a second adjusting unit, and output terminals of the first adjusting unit and the second adjusting unit are connected with the start terminal of the common electrode line.

24. The liquid crystal display according to claim 23, wherein the second adjusting unit is configured to transmit the recovery voltage signal to the common electrode line when the scan signal is either the high-voltage scan signal or the low-voltage scan signal, wherein the first adjusting unit is configured to transmit a low voltage signal to the common electrode line when a high-voltage scan signal is transmitted to the scan line, and wherein the adjusted voltage on the common electrode line is formed by the first and the second adjusting units.
